(19) United States
(12) Patent Application Publication
(10) Pub. No.: US 2011/0021253 A1
(43) Pub. Date: Jan. 27, 2011

(54) APPARATUS AND METHOD FOR REDUCING POWER CONSUMPTION IN PORTABLE TERMINAL

(75) Inventor: Yong-Noh LEE, Incheon (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/837,053

(22) Filed: Jul. 15, 2010

(30) Foreign Application Priority Data
Jul. 24, 2009 (KR) 10-2009-0067689

(51) Int. Cl. H04W 88/02; G06F 1/32

(52) U.S. Cl. 455/574; 713/320

(57) ABSTRACT

An apparatus and a method for reducing power consumption of a portable terminal. The apparatus includes a controller which induces the early release of a channel formed to transmit a synchronization determine signal.

### PRIORITY

This application claims the benefit under 35 U.S.C. §119(a) of a Korean patent application filed in the Korean Intellectual Property Office on Jul. 24, 2009, and assigned Serial No. 10-2009-0067689, the entire disclosure of which is hereby incorporated by reference.

### BACKGROUND OF THE INVENTION

1. Field of the Invention

The present invention relates to an apparatus and a method for reducing power consumption of a portable terminal. More particularly, the present invention relates to an apparatus and a method of the portable terminal for reducing power consumption by shortening a channel formation time to determine synchronization in a synchronization process.

2. Description of the Related Art

With recent rapid advances of portable terminals, portable terminals allowing wireless voice call and information exchange are becoming necessities. Initially, portable terminals featured portability and wireless communication. As portable terminal technologies developed, uses of portable terminals came to include not only the voice calls but also games, satellite broadcasting, remote control using short-range communication, image capturing using an embedded digital camera, and schedule management, to thus satisfy user's demands. Such additional functions of the portable terminal are often used much more than the wireless communication.

The development of batteries is not that notable compared to the rapid advances of the portable terminals. However, in response to the portability of the portable terminal, a smaller battery size is demanded, which limits the battery capacity. To support a number of the functions of the portable terminal with the limited battery capacity, it is necessary to increase the battery capacity and to reduce power consumption of the portable terminal. Among the functions of the portable terminals, audio and video playback, the camera, and the backlight illumination consume considerable battery power.

Recently, the portable terminal provides a synchronization function, which is quite convenient to the user, for fetching an e-mail received at an e-mail server to the portable terminal by synchronizing with the e-mail server. The synchronization function includes a manual mode for synchronizing only when the user selects the synchronization, a scheduled mode for synchronizing by time intervals preset by the user, and a push mode for synchronizing shortly after the change of a server/client. The push mode for synchronizing immediately after the change of the server/client sends a periodic ping message to the portable terminal or the synchronization server, and thus performs the synchronization when the change occurs.

The portable terminal builds a channel to send the ping message. Such a channel is maintained for a certain time even after the ping message is transmitted, and thus consumes power. To address this problem, an apparatus and a method for avoiding the unnecessary maintenance of the channel formed in the synchronization is needed.

### SUMMARY OF THE INVENTION

An aspect of the present invention is to solve at least the above-mentioned problems and/or disadvantages and to provide at least the advantages described below. Accordingly, an aspect of the present invention to provide an apparatus and a method for reducing power consumption of a portable terminal.

Another aspect of the present invention is to provide an apparatus and a method for providing a synchronization function to reduce power consumption in a portable terminal.

Another aspect of the present invention is to provide an apparatus and a method for reducing power consumption by shortening a channel formation time for synchronization determine in a portable terminal.

In accordance with an aspect of the present invention, an apparatus for reducing power consumption in a portable terminal is provided. The apparatus includes a controller for adjusting a maintenance time of a channel formed to transmit a synchronization update signal.

In accordance with another aspect of the present invention, a method for reducing power consumption in a portable terminal is provided. The method includes adjusting a maintenance time of a channel formed to transmit a synchronization update signal.

In accordance with another aspect of the present invention, a portable terminal is provided. The portable terminal includes a communication unit for communicating with a synchronization server; and a controller for forming a channel between the portable terminal and the synchronization server, for controlling the communication unit to transmit a synchronization update request to the synchronization terminal, for controlling the communication unit to transmit a channel release request to the synchronization server requesting a release of the channel after the synchronization update request has been transmitted, and for releasing the channel after receiving a response to the synchronization update request.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable terminal for synchronization according to an exemplary embodiment of the present invention;

FIG. 2 is a flowchart of a method for reducing battery consumption in synchronization of a portable terminal according to an exemplary embodiment of the present invention;

FIG. 3 is a flowchart of a method for reducing battery consumption in synchronization of a portable terminal according to an exemplary embodiment of the present invention;

FIG. 4A is a diagram of battery consumption in synchronization of a general portable terminal according to an exemplary embodiment of the present invention; and

FIG. 4B is a diagram of battery consumption in synchronization of a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and a method for reducing power consumption of a portable terminal by providing a synchronization function to reduce the power consumption and shortening a channel formation time for synchronization.

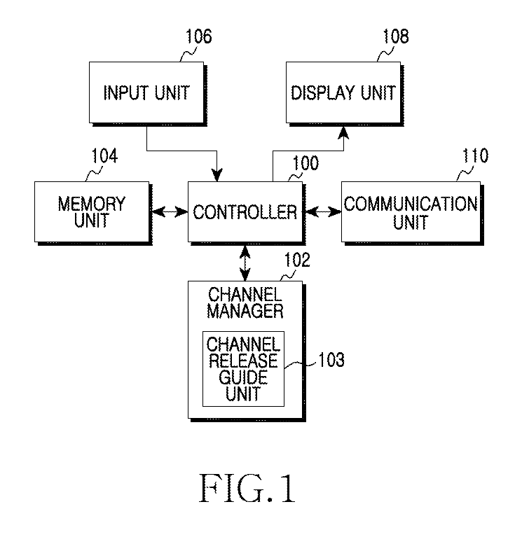

FIG. 1 is a block diagram of a portable terminal for synchronization according to an exemplary embodiment of the present invention.

Referring to FIG. 1, the portable terminal may include a controller 100, a channel manager 102, a memory unit 104, an input unit 106, a display unit 108, and a communication unit 110. The channel manager 102 can include a channel release guide unit 103. The portable terminal may include additional units. Similarly, the functionality of two or more of the above units may be integrated into a single component.

The controller 100 of the portable terminal controls operations of the portable terminal. For example, the controller 100 processes and controls voice communication and data communication, and synchronizes with a synchronization server by determining a synchronization time in the process of the synchronization. In addition to the typical functions, such as entering a push mode for synchronizing immediately after changes to the synchronization server or a client, the controller 100 transmits a synchronization update signal to the synchronization server by forming a channel for carrying the synchronization update signal. The synchronization update signal refers to a message sent to the synchronization server to determine whether the synchronization server has changed, such as by the addition of updated or additional content.

After transmitting the synchronization update signal, to reduce the power consumption caused by the unnecessary maintenance of the formed channel, the controller 100 transmits a signal to induce the channel release to the synchronization server via the communication unit 110. The controller 100 receives a channel release message from the synchronization message and releases the formed channel connection. The controller 100 controls the channel manager 102 to induce the channel release. Under the control of the controller 100, the channel manager 102 forms the channel for transmitting the synchronization update signal and then transmits the synchronization update signal to the synchronization server.

After transmitting the synchronization update signal to the synchronization server under the control of the controller 100, the channel manager 102 guides the channel release by transmitting a signal inducing the channel release to the synchronization server. The signal guiding the channel release is transmitted in order to avoid power consumption of the portable terminal by inducing the channel release after the synchronization update signal is transmitted. The portable terminal may not be able to release the channel itself. In addition, because the portable terminal builds the channel to transmit the synchronization update signal and it takes a short time to transmit the synchronization update signal, the formed channel is unnecessarily sustained over a certain time after the synchronization update signal is transmitted.

The channel manager 102 controls the channel release guide unit 103 to induce the channel release. To release the formed channel, the channel release guide unit 103 transmits the signal guiding the channel release to the synchronization server via the communication unit 110.

The memory unit 104 of the portable terminal includes a ROM, a RAM, a flash ROM, and the like. The ROM stores a microcode (i.e., code) and various reference data of programs for processing and controlling the controller 100 and the channel manager 102. The RAM, which is the working memory of the controller 100, stores temporary data generating in the program executions. The flash ROM stores updatable data such as phone book, outgoing messages, and incoming messages.

The input unit 106 includes a plurality of function keys, such as number buttons of 0˜9, a menu button, cancel button, an OK button, a call button, an end button, an Internet access button, navigation key buttons, character input keys, and the like. These keys are merely examples of keys which may make up the input unit 106; the input unit may include additional or different keys, or different input mechanisms through which the user supplies input to the portable terminal. The input unit 106 provides the controller 100 with key input data corresponding to the key pressed by the user.

The display unit 108 displays status information, characters, videos, and still images generating in the operation of the portable terminal. The display unit 108 may employ a color Liquid Crystal Display (LCD), Active Mode Organic Light Emitting Diode (AMOLED), and the like. When a touch input device is applied to a touch-type portable terminal, the display unit 108 may be used as the input device.

The communication unit 110 transmits and receives radio or other wireless signals via an antenna (not illustrated). For example, during the transmission of the radio signals, the communication unit 110 channel-codes, spreads, Radio Frequency (RF)-processes, and transmits data. During the reception of the radio signals, the communication unit 110 converts the received RF signal to a baseband signal and restores the data by de-spreading and channel-decoding the baseband signal. According to an exemplary embodiment of the present invention, the communication unit 110 transmits a message for inducing the channel release.

The controller 100 of the portable terminal can function as the channel manager 102. The controller 100 and the controller 102 are separately provided to distinguish their functions, not to limit the scope of the present invention. One skilled in the art shall understand various modifications without departing from the scope and spirit of the invention. For example, the controller 100 can process all of the functions of the channel manager 102.

A method for reducing the power consumption of the portable terminal using the apparatus according to an exemplary embodiment of the present invention is described below.

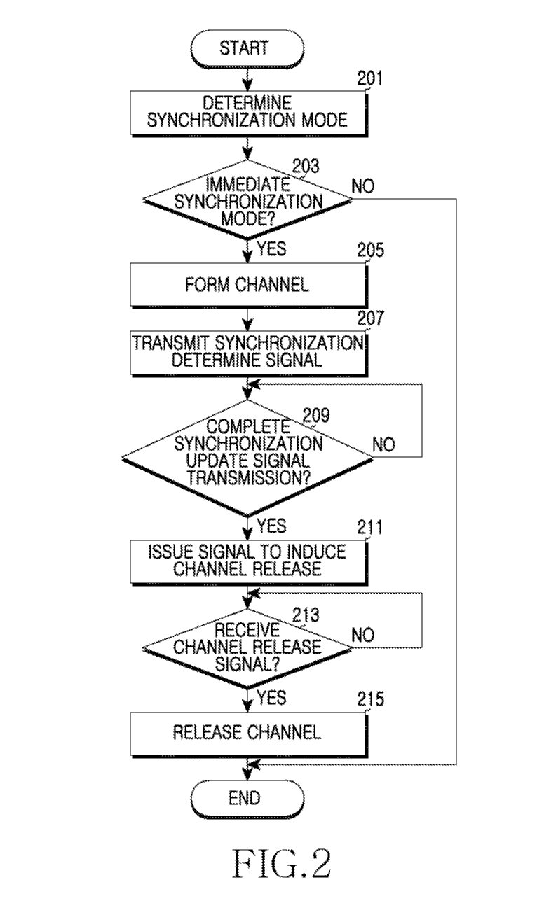

FIG. 2 is a flowchart of a method for reducing battery consumption in synchronization of a portable terminal according to an exemplary embodiment of the present invention.

Referring to FIG. 2, the portable terminal determines the synchronization mode in step 201. The determining of the synchronization mode includes determining the mode in which the portable terminal synchronizes with the synchronization server using a synchronization program such as ActiveSync. The synchronization mode includes a manual mode for synchronizing only when the user selects the synchronization, a scheduled mode for synchronizing by time intervals preset by the user, and a push mode for synchronizing shortly after the change of a server or a client. In step 203, the portable terminal determines whether the current mode is an immediate synchronization mode, i.e., a mode in which the synchronization is performed immediately for every change in the server or the client. The process concludes upon determining that it is not the immediate synchronization mode in step 203.

If the portable terminal determines that the current mode is the immediate synchronization mode in step 203, the portable terminal builds the channel for transmitting the synchronization determine signal in step 205. The portable terminal forms the channel for transmitting the synchronization signal such as ping message, to determine any change in the synchronization server.

In step 207, the portable terminal transmits the synchronization update signal, over the channel, and determines whether the synchronization update signal transmission is completed in step 209. While the portable terminal establishes the channel to the server to transmit the synchronization update signal, the time taken to transmit the synchronization update signal is longer than the time taken to form and sustain the channel. Since the portable terminal forms the channel even after transmitting the synchronization update signal, excess power is consumed in the channel establishment.

To address the power consumption problem in the unnecessary channel formation, the portable terminal operates as follows according to an exemplary embodiment of the present invention.

The portable terminal repeats step 209 until the synchronization update signal is transmitted. Upon completing the synchronization determine signal transmission in step 209, the portable terminal transmits the signal guiding the channel release to the synchronization server in step 211. Since the portable terminal itself cannot release the channel, in step 211, the portable terminal transmits the signal guiding the early channel release in order to reduce the power consumption before the channel is released. Upon receiving the signal guiding the channel release, the synchronization server transmits the signal for releasing the channel to the portable terminal.

In step 213, the portable terminal transmitting the signal guiding the channel release determines whether the signal for releasing the formed channel is received from the synchronization server, and waits until the signal has been received from the synchronization server. Once the signal for releasing the channel is received in step 213, the portable terminal releases the channel to the server in step 215. This reduces the power consumption by preventing unnecessary channel formation, and releases the formed channel in advance after the synchronization determine signal is transmitted.

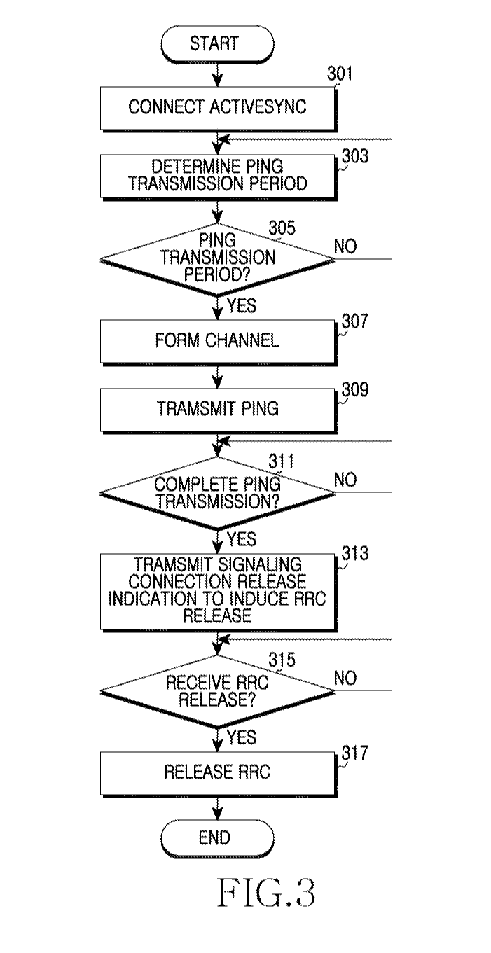

FIG. 3 is a flowchart of a method for reducing battery consumption in synchronization of a portable terminal according to an exemplary embodiment of the present invention.

Referring to FIG. 3, the portable terminal connects the ActiveSync which is the synchronization program in step 301, and then determines the ping message transmission period in step 303. The portable terminal transmits the ping message to determine a change in the synchronization mode. In step 305, the portable terminal examines the result of step 303, and repeats step 303 until the ping transmission period is determined. When determining the ping message transmission period in step 305, the portable terminal performs RRC connection to establish the channel for the data communication with the synchronization server in order to transmit the ping message in step 307.

The portable terminal transmits the ping message to the synchronization server over the channel generated in step 307, in step 309, and determines whether the ping message transmission is completed in step 311. The portable terminal repeats step 311 until the ping message is transmitted.

When completing the ping message transmission in step 311, the portable terminal transmits a “Signaling connection release indication” defined in 3GPP 25.331 to the synchronization server to induce the RRC release in step 313. The portable terminal performs step 313 to compel the channel release after the ping message is transmitted in order to reduce the power consumed by the unnecessary channel sustained for a certain time after the ping message is transmitted. The synchronization server, upon receiving the “Signaling connection release indication” signal to lead the RRC release in step 313, transmits an RRC connection release message to the portable terminal.

In step 315, the portable terminal receiving the signal for guiding the RRC release determines whether the message for releasing the formed RRC is received from the synchronization server. The message for releasing the RRC releases the RRC earlier than the RRC connection time which is formed to transmit the ping message in the conventional portable terminal. The message for releasing the RRC can reduce the power consumption in the unnecessary RRC connection by releasing the RRC after the ping message is transmitted. The portable terminal repeats step 315 until the message for releasing the formed RRC is received. Upon receiving the message for releasing the formed RRC in step 315, the portable terminal releases the formed RRC in step 317.

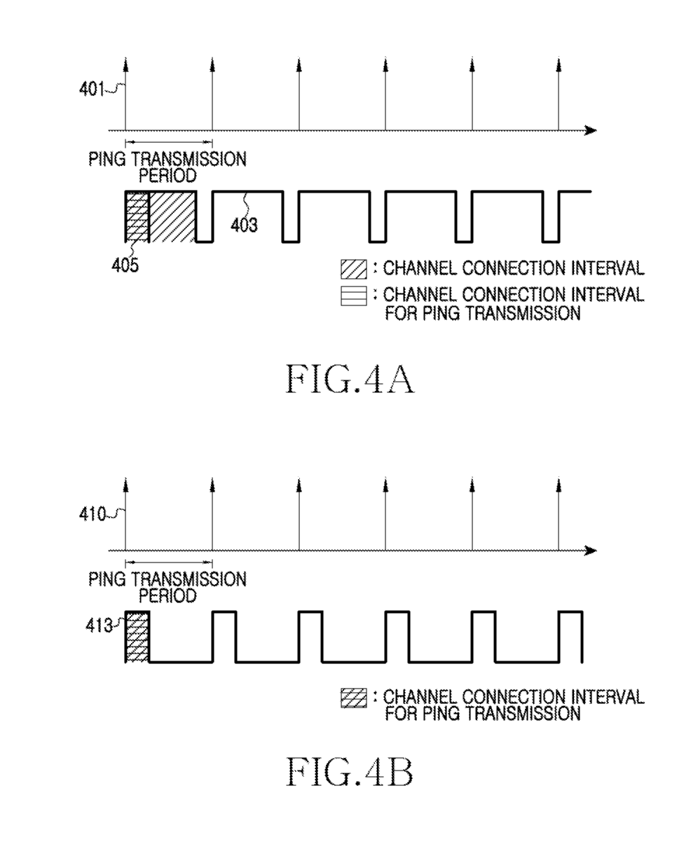

FIG. 4 depicts battery consumption in synchronization of a portable terminal according to an exemplary embodiment of the present invention and a general portable terminal.

FIG. 4A shows battery consumption in synchronization of a general portable terminal according to an exemplary embodiment of the present invention.

Referring to FIG. 4A, to determine the synchronization time point; that is, any change in the synchronization server, the portable terminal transmits the ping message 401 to the synchronization server after each of the ping message transmission periods. In so doing, the portable terminal forms the channel for the data communication with the synchronization server to transmit the ping message, and maintains the channel formation 403 over a certain time before the ping message of the next period is transmitted.

The portable terminal forms the channel for the data communication with the synchronization server to transmit the ping message. However, after transmitting the ping message 405, the portable terminal does not release the channel before the channel setup time. As a result, the portable terminal maintains the unnecessary channel formation from the ping message transmission completion until the channel release according to the channel setup time.

FIG. 4B shows battery consumption in synchronization of a portable terminal according to an exemplary embodiment of the present invention.

Referring to 4B, to determine the synchronization time point; i.e., a change in the synchronization server, the portable terminal transmits the ping message 410 to the synchronization server after each of the ping message transmission periods. Similar to the conventional portable terminal, the portable terminal forms the channel for the data communication with the synchronization server to transmit the ping message. By transmitting the message guiding the channel release to the server according to an exemplary embodiment of the present invention, the portable terminal prevents the maintaining of an unnecessary channel from the ping message transmission completion until the channel release according to the channel setup time. After transmitting the ping message 413, the portable terminal shortens the channel formation time by releasing the formed channel, to thus reduce the power consumption.

As set forth above, according to the apparatus and the method for reducing the power consumption of the portable terminal according to exemplary embodiments of the present invention, power consumption in the channel formation of the conventional portable terminal can be addressed by shortening the channel formation time for the synchronization determination in a synchronization process.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for reducing power consumption in a portable terminal, the apparatus comprising:
a controller for adjusting a maintenance time of a channel formed to transmit a synchronization update signal.

2. The apparatus of claim 1, further comprising:
a channel manager for transmitting the synchronization update signal over the channel formed to transmit the synchronization update signal, and inducing a release of the formed channel when the transmission of the synchronization update signal is completed.

3. The apparatus of claim 2, wherein, after the channel release is induced, the formed channel is released when a channel release message is received.

4. The apparatus of claim 2, wherein the channel manager induces the release of the formed channel by transmitting a Signaling connection release indication signal to guide RRC release.

5. The apparatus of claim 1, wherein the synchronization update signal is a signal to determine whether a synchronization server has changed.

6. A method for reducing power consumption in a portable terminal, the method comprising:
adjusting a maintenance time of a channel formed to transmit a synchronization update signal.

7. The method of claim 6, further comprising:
transmitting the synchronization update signal over the formed channel; and
inducing a release of the formed channel when the transmission of the synchronization update signal is completed.

8. The method of claim 7, further comprising:
after inducing the channel release, releasing the formed channel when a channel release message is received.

9. The method of claim 7, wherein the inducing of the release of the formed channel comprises transmitting a Signaling connection release indication signal to guide RRC release.

10. The method of claim 6, wherein the synchronization update signal is a signal to determine whether a synchronization server has updated.

11. An apparatus for reducing power consumption in a portable terminal, comprising:
a channel manager for, after transmitting a synchronization update signal to determine whether a synchronization server has updated, generating a release signal which induces a release of a channel over which the synchronization update signal was transmitted and for transmitting the release signal to the synchronization server.

12. A method for reducing power consumption in a portable terminal, comprising:
after transmitting a synchronization update signal to determine whether a synchronization server has updated, generating a release signal which induces a release of a channel over which the synchronization update signal was transmitted; and
transmitting the generated release signal to the synchronization server.

13. A portable terminal comprising:
a communication unit for communicating with a synchronization server; and
a controller for forming a channel between the portable terminal and the synchronization server, for controlling the communication unit to transmit a synchronization update request to the synchronization terminal, for controlling the communication unit to transmit a channel release request to the synchronization server requesting a release of the channel after the synchronization update request has been transmitted, and for releasing the channel after receiving a response to the synchronization update request.

14. The portable terminal of claim 13, wherein the controller further comprises a channel manager for forming the channel between the portable terminal and the synchronization server.

15. The portable terminal of claim 13, wherein the controller further comprises a channel release guide unit for controlling the communication unit to transmit the channel release request to the synchronization server and for releasing the channel after receiving the response to the synchronization update request.

16. The portable terminal of claim 13, wherein the synchronization update request is a ping message.

17. The portable terminal of claim 14, wherein the controller controls the communication unit to transmit the synchronization update request at periodic intervals.
